(19) United States
(12) Patent Application Publication
(10) Pub. No.: US 2025/0238351 A1
(43) Pub. Date: Jul. 24, 2025

(54) SYSTEM AND METHOD FOR EPIC CODE ANALYSIS FOR A USER STORY

(71) Applicant: TRICENTIS ISRAEL LTD, Tel Aviv-Yafo (IL)

(72) Inventors: Alon Eizenman, Ra’anana (IL); Eran Sher, Ra’anana (IL); Jason Wides, Ra’anana (IL); Yaniv Levin, Ra’anana (IL)

(21) Appl. No.: 19/033,325

(22) Filed: Jan. 21, 2025

Related U.S. Application Data
(60) Provisional application No. 63/623,413, filed on Jan. 22, 2024.

(51) Int. Cl. G06F 11/3668

(52) U.S. Cl. CPC G06F 11/3676; G06F 11/368; G06F 11/3688

(57) ABSTRACT

A system and methods are provided that are configured for analyzing code coverage in relation to user stories. The system includes a non-transitory memory and one or more hardware processors that cause the system to perform operations comprising receiving a user story definition for software code and analyzing the software code by managing executions of tests for determination of the code coverage of the software code in relation to the user story definition, performing the tests using one or more test runners, determining test results, performing the analysis of the code coverage based at least on the test results, and determining whether the software code is ready for a release or the tests require a refinement for a further analysis. The operations may further comprise outputting information associated with whether the software code is ready for the release, or the tests require the refinement for the further analysis.

### CROSS REFERENCE TO RELATED APPLICATION

This application claims priority to and the benefit of U.S. Provisional Patent Application No. 63/623,413, filed Jan. 22, 2024, which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present technology pertains to the field of software development and testing, more specifically to systems and methods for analyzing code coverage in relation to user story requirements. It involves the integration of development and quality assurance (QA) processes to ensure that code changes are adequately tested against predefined user stories, thereby facilitating the assessment of whether software code modifications meet the intended functionality and performance criteria as described by the user stories.

### BACKGROUND

In software development, user stories describe the features and functionalities that end users require from a software system. These user stories serve as a basis for defining the tasks that developers and QA teams work on. Traditionally, the development and testing of software have been treated as separate processes, often leading to a disconnect between the code that is written and the extent to which it fulfills the user story requirements. This can result in software releases that do not fully meet user expectations or contain untested or under-tested code, leading to potential defects and increased maintenance costs.

There is a growing demand for tools and methods that can bridge the gap between development and QA processes, ensuring that every aspect of a user story is covered by tests and that the code is ready for release. As such, there is a need in the software development industry to analyze and correlate code changes with user story requirements and test coverage in an efficient, compatible, and comprehensive manner while reducing errors and issues with code releases from untested or under-tested code.

### SUMMARY

The present disclosure, in at least some embodiments, addresses the aforementioned challenges by providing a system and method for analyzing code coverage in relation to user stories. The technology integrates user story definitions with both development and testing processes to ensure comprehensive test coverage and alignment with user requirements. The system includes a user story analyzer that combines inputs from the development process, such as code changes, with inputs from the testing process, including designed tests and test results, to analyze test coverage in relation to user stories.

The system further includes a build mapper and a code change analysis system that determine the relevance of tests based on code changes, and a cloud system that calculates code coverage for each test. A machine learning system may be employed to refine the correlation of tests to coverage data. The technology enables the creation of dashboards or reports that show the extent to which test coverage and code changes conform to the user story, thereby facilitating informed decisions about code readiness for release.

The disclosed technology provides a detailed framework for analyzing and correlating code changes and test coverage with user story requirements. It involves several components and processes that work in conjunction to ensure that the code developed by the software team meets the criteria set forth by the user stories.

The process begins with the definition of a user story, which is then input into both the development and testing processes. The development team designs and develops the code, performing unit and component tests. Simultaneously, the QA team designs progression and regression tests based on the same user story. The results from both processes are fed into the user story analyzer, which assesses test coverage in relation to the user story.

The system includes a source control component, a user story analyzer, test management, test runners, and a cloud system. The user story analyzer receives code from source control, along with user story definitions, and analyzes the code coverage based on information from the cloud system. The test management component manages the tests, which are performed by the test runners. The cloud system provides overall coverage information to the user story analyzer.

This component of the system includes a build mapper, an executable code processor, a test listener, and an analysis engine. The build mapper determines the relevance of tests based on code changes, while the analysis engine analyzes test results and determines the relationship between tests and code changes.

The system allows for the correlation of user story definitions to code coverage. A user story management system, such as Jira, feeds the user story definition to the analysis engine, which also receives code changes and mappings from the code change analysis system. The analysis engine then correlates the test coverage to the user story definition.

According to at least some embodiments, there is provided a method, which involves receiving a user story definition, code changes, and test coverage information. The test coverage is mapped to the code changes, and the coverage information for code related to the user story is aggregated. A dashboard or report is then created to show the extent of test coverage in relation to the user story. The dashboards may visually map test code coverage to the user story definition, highlighting any deficiencies in coverage and untested code in relation to the user story.

The code change analysis system includes an analyzer, which may be a machine learning analyzer, and an output correlator. The analyzer applies an algorithm to determine the relative importance of tests to specific code sections, while the output correlator formats information for the analyzer.

Optionally, a user story is defined, followed by creating and assigning coding tasks, linking code to tasks and user stories, performing tests on the code, and linking code coverage to the user story.

Overall, the disclosed technology provides a comprehensive approach to ensuring that software development aligns with user story requirements through meticulous analysis of code changes and test coverage.

Implementation of the present method and system involves performing or completing certain selected tasks or steps manually, automatically, or a combination thereof. Moreover, according to actual instrumentation and equipment of the preferred embodiments, several selected steps could be implemented by hardware or by software on any operating system of any firmware or a combination thereof. For example, as hardware, selected steps described herein may be implemented as a chip or a circuit. As software, selected steps described herein may be implemented as a plurality of software instructions being executed by a computer using any suitable operating system. In any case, selected steps of the method and system described herein could be described as being performed by a data processor, such as a computing platform for executing a plurality of instructions.

Unless otherwise defined, all technical and scientific terms used herein have the same meaning as commonly understood by one of ordinary skill in the art to which this disclosure belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions. The processor is configured to execute a predefined set of operations in response to receiving a corresponding instruction selected from a predefined native instruction set of codes.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 shows a non-limiting, exemplary process for code analysis based on user stories according to some embodiments;

FIG. 2 shows a non-limiting, exemplary system for code analysis based on user stories according to some embodiments;

FIG. 3 shows a non-limiting, exemplary system for analyzing builds to determine which tests are relevant according to some embodiments;

FIG. 4 relates to an optional code change analysis system in more detail according to some embodiments;

FIG. 5 shows a non-limiting, exemplary system for correlating a user story definition to code coverage according to some embodiments;

FIG. 6 shows a non-limiting, exemplary method for analyzing test code coverage based on a user story according to some embodiments;

FIG. 7 shows a non-limiting, exemplary code change analysis system, in an implementation which may be used with any of systems and/or processes as described above, or any other system or process as described herein, according to some embodiments;

FIG. 8 shows a non-limiting, exemplary method for determining how code coverage correlates to the user story according to some embodiments;

FIGS. 9A and 9B show non-limiting, exemplary dashboards according to some embodiments;

FIG. 10 shows a simplified diagram of an exemplary flowchart for code analysis based on a user story according to some embodiments; and

FIG. 11 shows a simplified diagram of a computing device according to some embodiments.

### DETAILED DESCRIPTION

This description and the accompanying drawings that illustrate aspects, embodiments, implementations, or applications should not be taken as limiting-the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

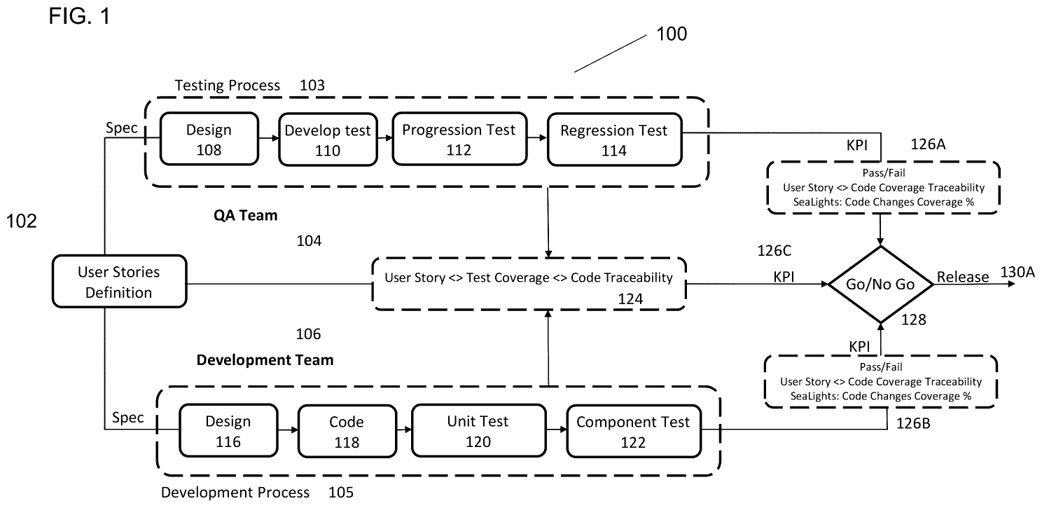

FIG. 1 shows a non-limiting, exemplary process for code analysis according to user stories. As shown, a process 100 features a user story definition 102, which may be determined through any suitable tool, including but not limited to Jira and the like. User story definition 102 is input to two different processes. At the top, a testing process 103 is performed by a QA team 104, operating through at least one user computational device (not shown). Testing process 103 receives user story definition 102, and then begins by designing one or more tests and the test process at 108. Next, the designed tests are developed at 110. The tests are then separated into progression tests at 112, which are new tests that are run; and regression tests at 114, which are tests used to validate previously run tests.

At the bottom, a development process 105 is performed by a development team 106, operating through at least one user computational device (not shown). Development process 105 receives user story definition 102, and then begins by designing the code to be created at 116. Reference to “code” relates to modifications to the code, including new and/or changed code, throughout the specification. The code is then developed at 118, after which unit tests are performed at 120, followed by component tests at 122. These tests are typically created by the developers. Unit tests consider specific methods or other units of code. Component tests consider functionality and interactions between tests. The tests created by QA team 104 may also include end-to-end tests, analyzing interactions between different applications, and/or interactions between the code and the environment or other systems.

The design of the tests, the tests themselves, the user story, the code and the test results are fed into a user story analyzer 124, in which both aspects of development process 105 and testing process 103 are combined, in terms of analyzing test coverage in relation to user stories.

At 126, it is determined whether the code is ready to be released, in a three-part process. At 126A, the output of testing process 103 is analyzed to determine whether the code is ready to be released, according to QA requirements. At 126B, the output of testing process 103 is analyzed to determine whether the code is ready to be released, according to development requirements. At 126C, the output of testing process 103 is analyzed to determine whether the code is ready to be released, according to the user story and its requirements.

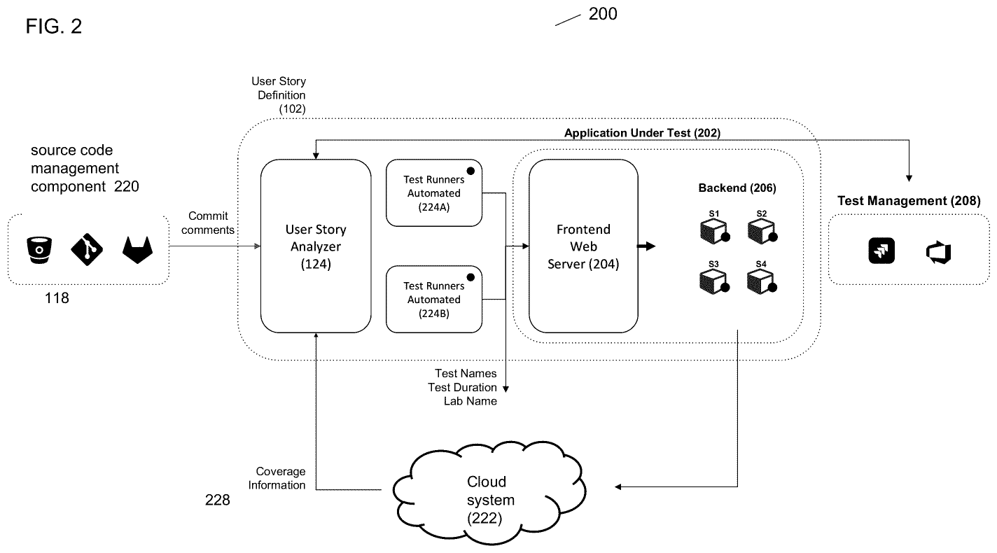

FIG. 2 shows a non-limiting, exemplary system for code analysis according to user stories. Items with the same reference number have the same or at least similar functions. As shown, a system 200 features code to be analyzed 118 according to user story definition, from a source code management component 220, which may comprise Bitbucket, Github, GitLab, and the like. For example, source code management component 220 may comprise, correspond to, be associated with, and/or utilize an external source code repository, third-party source code repository, or internal and/or proprietary source code repository. Such source code repository may further provide a collaboration space to collaborate on and deploy code, a hosting service for the source code and collaboration space, and other tools, applications, interfaces, and the like to code developers for source code writing, updating, configuring, and/or testing. User story analyzer 124 receives such code, along with any comments, as well as user story definition 102. User story analyzer 124 also receives application under test 202, which is also sent to a test management 208.

Test management 208 manages the tests to be performed, which are performed through one or more test runners 224A and 224B, of which two are shown for the sake of description only and without any intention of being limiting. Test runners 224A and 224B send the test names, test duration and test environment name to a cloud system 222. Test runners 224A and 224B also run the tests, the results of which are sent to a frontend server 204, for the user running the tests to view. The results are also sent to a backend server 206, which sends tests that were run and code that was tested sent to cloud system 222. Frontend server 204 and backend server 206 may also send information regarding scripts that run and other external information. Cloud system 222 then provides overall coverage information 228 to user story analyzer 124. Alternatively, user story analyzer 124 pulls this information from cloud system 222, whether periodically or in response to a message.

User story analyzer 124 may obtain code that is related to the user story, particularly modified or changed code. User story analyzer 124 may then check whether that code has been covered by one or more tests, according to information received from cloud system 222. User story analyzer 124 may then compare such coverage information to user story definition 102, to determine the extent to which the requirements of the user story have been adequately tested.

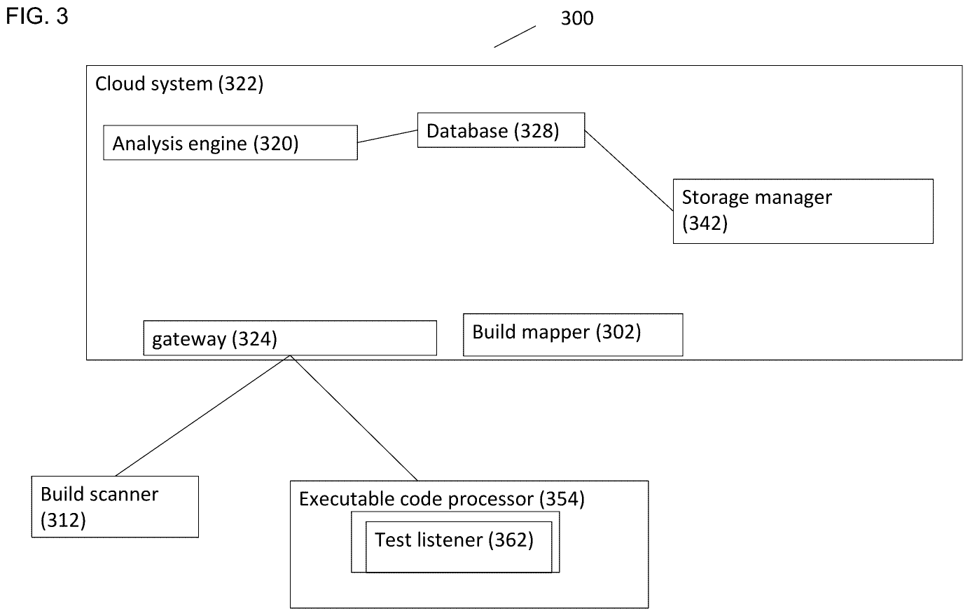

FIG. 3 shows a non-limiting, exemplary system for analyzing builds to determine which tests are relevant. As shown in a system 300, an executable code processor 354 executes a test. Test listener 362 monitors the test and its results and causes one or more tests to be performed.

Test information is sent first to a storage manager 342 and then to an analysis engine 320, optionally through a database 328. Analysis engine 320 determines whether or not test code coverage should be updated, how it should be updated, whether any code has not been tested, and so forth. This information is stored in database 328 and is also passed back to gateway 324. As shown, the test listener functions of FIG. 3 may be performed by test listener 362 alone or in combination with analysis engine 320.

A build mapper 302 determines the relevance of one or more tests, according to whether the code that is likely covered by such tests has changed. Such a determination of likely coverage and code change in turn may be used to determine which tests are relevant, and/or the relative relevance of a plurality of tests. Build mapper 302 may be operated through cloud system 322.

Build mapper 302 receives information about a new build and/or changes in a build from a build scanner 312. Alternatively, such functions may be performed by analysis engine 320. Build mapper then receives information about test coverage, when certain tests were performed and when different portions of code were being executed when such tests were performed, from test listener 362 and/or analysis engine 320.

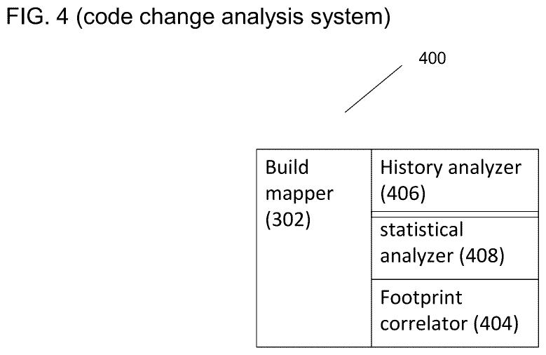

Build mapper 302 communicates with a plurality of additional components, such as a footprint correlator 404 for example, as shown with regard to FIG. 4, for determining which tests relate to code that has changed, or that is likely to have changed, as well as for receiving information regarding code coverage. FIG. 4 relates to an optional code change analysis system 400 in more detail. Footprint correlator 404 in turn communicates such information to a history analyzer 406 and a statistical analyzer 408 (also shown in FIG. 4). History analyzer 406 and statistical analyzer 408 are optionally present; footprint correlator 404 may receive such information from another source (not shown).

History analyzer 406 assigns likely relevance of tests to the new or changed code, based on historical information. Such likely relevance is then sent to statistical analyzer 408. Statistical analyzer 408 determines statistical relevance of one or more tests to one or more sections of code, preferably new or changed code. For example, such statistical relevance may be determined according to the timing of execution of certain tests in relation to the code that was being executed at the time. Other relevance measures may also optionally be applied. Information regarding the results of the build history map and/or statistical model are stored in a database, such as database 328.

Turning back to FIG. 3, various tests may be performed through cloud system 322, which may be performed according to one or more policies or rules. Non-limiting examples of such rules include a preference for impacted tests, previously used at least once, that cover a footprint in a method that changed in a given build. In some embodiments, recently failed tests may be performed again. New tests that were added recently or modified tests may be performed again. Tests that were recommended in the past but were not executed since then may have a preference to be performed. Tests that are covering code that is being used in production may be preferred, particularly in case of inclusion of one of the above rules. Other code related rules may include but are not limited to tests that are covering code that was modified multiple times recently, and/or tests that are covering code that is marked manually or automatically as high-risk code.

Cloud system 322 performs calculations of the code coverage for each test that was executed in any given test environment. The per test coverage is calculated based on a statistical correlation between a given time frame of the tests that were executed with the coverage information being collected during this time frame, as described above and in greater detail below.

Optionally, a machine learning system may be used to refine the aforementioned correlation of tests to coverage data. Such a system may be applied, due to the fact that test execution is not deterministic by nature and the fact that tests may run in parallel, which may render the results even more non-deterministic.

Although not shown, cloud system 322 may feature a processor and a memory, or a plurality of these components, for performing the functions as described herein. Functions of the processor may relate to those performed by any suitable computational processor, which generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as the memory described above in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, the memory is configured for storing a defined native instruction set of codes. The processor is configured to perform a defined set of basic operations in response to receiving a corresponding basic instruction selected from the defined native instruction set of codes stored in the memory. For example and without limitation, the memory may store a first set of machine codes selected from the native instruction set for receiving information from build scanner 312 about a new build and/or changes in a build; a second set of machine codes selected from the native instruction set for receiving information about test coverage, when certain tests were performed and when different portions of code were being executed when such tests were performed, from test listener 362 and/or analysis engine 320; and a third set of machine codes from the native instruction set for operating footprint correlator 404, for determining which tests relate to code that has changed, or that is likely to have changed, as well as for receiving information regarding code coverage.

The memory may store a fourth set of machine codes from the native instruction set for communicating such changed code and/or code coverage information to a history analyzer 406, and a fifth set of machine codes from the native instruction set for assigning likely relevance of tests to the new or changed code, based on historical information. The memory may store a sixth set of machine codes from the native instruction set for communicating such changed code and/or code coverage information to statistical analyzer 408, and a seventh set of machine codes from the native instruction set for determining statistical relevance of one or more tests to one or more sections of code, preferably new or changed code.

Analysis engine 320 then receives the test results from test listener 362 and the test details (including the framework) from a test runner (not shown, see FIG. 2). Analysis engine 320 then analyzes the result of executing at least one test, based on the received information. The analysis may include determining whether a test executed correctly, whether a fault was detected, and so forth.

Preferably, analysis engine 320 also receives information regarding the build and changes to the code from build mapper 302. Such build information assists in the determination of whether a particular test relates to a change in the code.

Optionally the components shown in FIGS. 3 and 4 are not co-located. For example, Test listener 362 and the test runner (not shown) may be located separately from build mapper 302 and/or build scanner 312, each of which may be located at cloud system 322 or at a separate location.

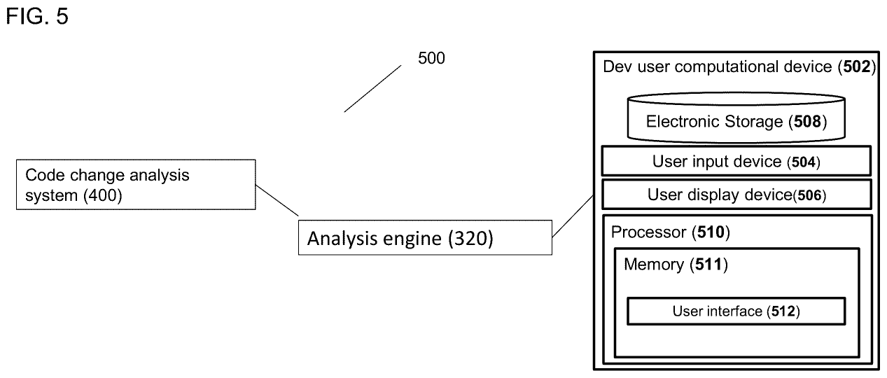

FIG. 5 shows a non-limiting, exemplary system for correlating a user story definition to code coverage. As shown in a system 500, the user story definition may be provided through a developer (dev) user computational device 502, or through another system (not shown). The user story definition is then fed to analysis engine 320, as are code changes and mapping of code to tests from code change analysis system 400. Dev user computational device 502 may also control which code is to be considered with regard to a particular user story definition. Dev user computational device 502 may also control which test results are to be analyzed for determining code coverage, for mapping test results to the code, and for mapping test results and code to the user story definition. Alternatively, some or all of these functions may be performed separately (not shown). Dev user computational device 502 is a non-limiting example of a user story management system, such as Jira for example, which may operate according to user input only, or according to a combination of user input and automation.

Dev user computational device 502 features a user interface 512, for performing the above functions. User interface 512 is in turn provided according to instructions stored in a memory 511 and executed by a processor 510. Processor 510 and memory 511, or a plurality of these components, support performance of the functions of dev user computational device 502 as described herein. Functions of processor 510 may relate to those performed by any suitable computational processor, which generally refers to a device or combination of devices having circuitry used for implementing the communication and/or logic functions of a particular system. For example, processor 510 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory, such as the memory described above in this non-limiting example. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Also optionally, memory 511 is configured for storing a defined native instruction set of codes. Processor 510 is configured to perform a defined set of basic operations in response to receiving a corresponding basic instruction selected from the defined native instruction set of codes stored in memory 511.

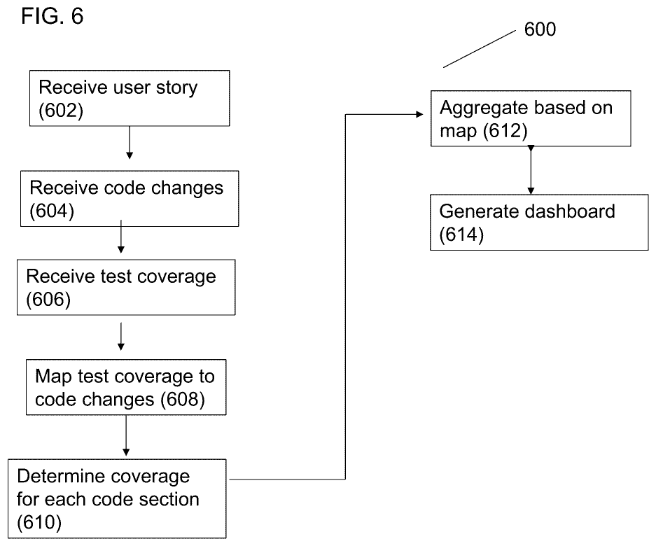

FIG. 6 shows a non-limiting, exemplary method for analyzing test code coverage according to a user story. As shown, a method 600 begins at 602, when a user story definition is received. At 604, a plurality of code changes is received, optionally from an external system, such as Github. Such an external system may also provide a mapping of the code changes to the existing code. Alternatively, such a mapping may be performed by the system as described herein. At 606, test coverage is received for the code changes, such that coverage of the tests is mapped to the code changes. At 608, the test coverage is mapped to the code changes.

Next, at 610, for the code that is related to the user story, the amount of coverage is determined in relation to the user story, for each section of relevant code. As noted previously, relevant code preferably comprises new, modified and/or changed code. This stage may be repeated until the amount of coverage is determined for each section of code that is relevant to the user story. Such code sections may come from many locations in the overall application or system of applications. At 612, such coverage information for at least some, but preferably all of the sections of code, is aggregated based upon the map of the code to the user story, to show which code related to the user story has been tested, and to which extent it has been tested. At 614, a dashboard and/or a report is created, showing the extent to which the test coverage and the code changes conform to the user story.

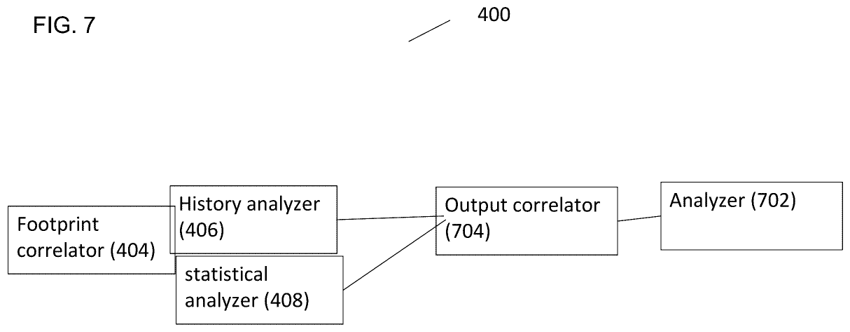

FIG. 7 shows a non-limiting, exemplary code change analysis system, in an implementation which may be used with any of systems and/or processes as described above, or any other system or process as described herein. The implementation may be operated by a processor with memory and/or another cloud system as described above. Components with the same numbers as in previous figures have the same or similar function. Code change analysis system 400 features an analyzer 702, which may be implemented as a machine learning analyzer. Analyzer 702 receives information from history analyzer 406 and statistical analyzer 408. Analyzer 702 then applies an algorithm, such as a machine learning model, to determine the relative importance of a plurality of tests to particular code, files or methods.

Preferably, an output correlator 704 receives information from history analyzer 406 and statistical analyzer 408 and transmits this information to analyzer 702. Such transmission may enable the information to be rendered in the correct format for analyzer 702. Optionally, if history analyzer 406 and statistical analyzer 408 are also implemented according to machine learning, or other adjustable algorithms, then feedback from analyzer 702 may be used to adjust the performance of one or both of these components.

Once a test stage finishes executing, optionally with a “grace” period for all agents to submit data (and the API gateway to receive it), then the following data is available to analyzer 702: a build map, a test list, and time slices. A build map relates to the code of the build and how it has changed. For example, this may be implemented as a set of unique IDs+code element IDs which are persistent across builds. The test list is a list of all tests and their start/end timing. Time slices may include high-time-resolution slicing of low-coverage-resolution data (e.g. file-level hits [or method hits] in 1-second intervals).

The first step is to process the data to correlate the footprint per test (or a plurality of tests when tests are run in parallel). The second step is model update for the machine learning algorithm, if one is used. Based on the build history, the latest available model for a previous build is loaded (ideally this should be the previous build). If no such model exists, it is possible to assume an empty model with no data, or an otherwise untrained machine learning algorithm. The model consists of a set of test +code element ID mapping (which are the key) and a floating point number that indicates the correlation between the test and the code element ID. Such correlation information is determined by statistical analyzer 108. For example, a “1.0” means the highest correlation, whereas a 0 means no correlation at all (the actual numbers will probably be in between).

For any test+code element ID, the method updates each map element, such as each row, according to the results received. For example, updating may be performed according to the following formula: NewCorrelation [test i, code element ID j]=OldCorrelation [test i, code element ID j]*0.9+ (0.1 if there is a hit, 0 otherwise). This type of updating is an example of a heuristic which may be implemented in addition to, or in place of, a machine learning algorithm. Preferably these coefficients always sum up to 1.0, so there is effectively a single coefficient that relates to the speed (number of builds). For example, it is possible to do a new statistical model after each set of tests run, optionally per build.

Next, a cleanup step is performed where old correlations are deleted for code elements that no longer exist in the new build. Optionally a further cleanup step is performed where old tests are deleted, and methods that are very uncorrelated with tests (e.g. <0.1).

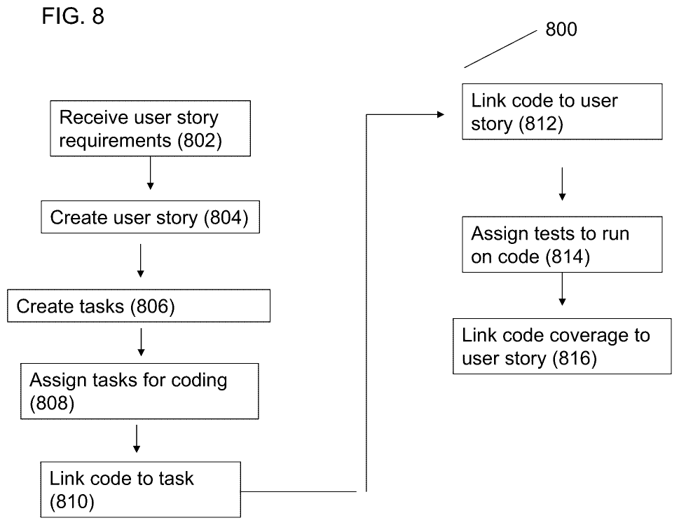

FIG. 8 shows a non-limiting, exemplary method for determining how code coverage correlates to the user story. As shown in a method 800, the method begins at 802, when user story requirements are received. Next a user story is defined at 804, to create a user story definition. At 806, a plurality of tasks is created in relation to coding. At 808, these tasks are assigned to developers. At 810, the code that is created is linked to a task. Next, at 812, the code is linked to a user story from the user story management system. At 814, one or more tests are performed on the code, resulting in code coverage being determined. At 816, the code coverage is linked to the user story.

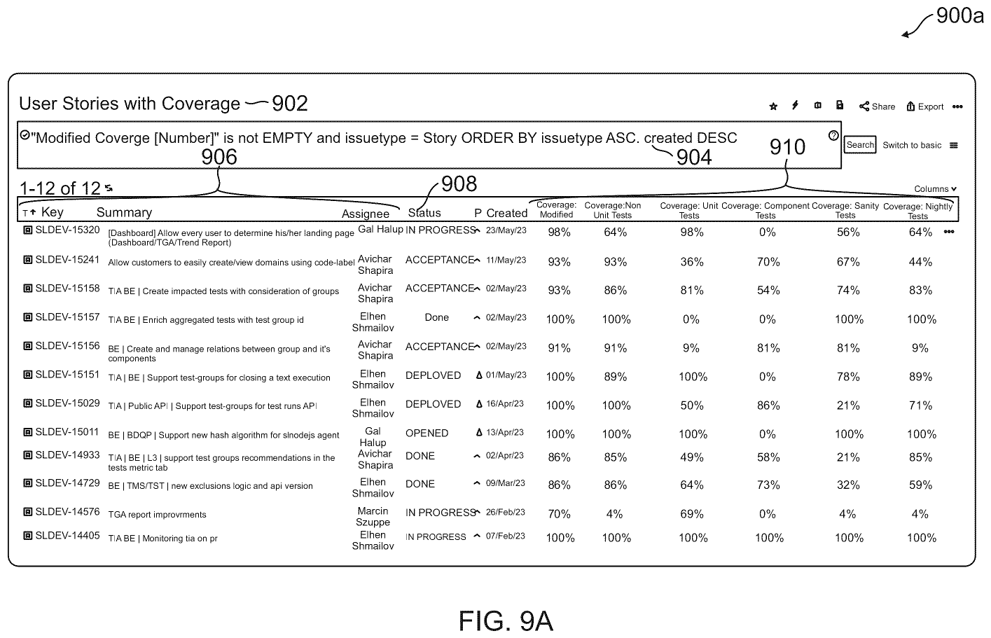

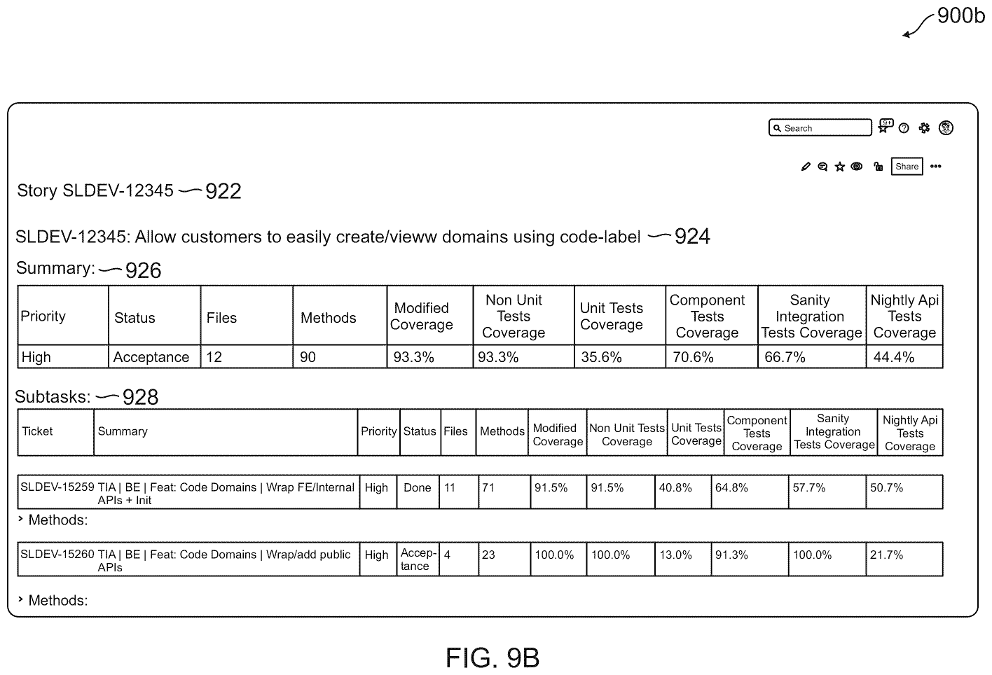

FIGS. 9A and 9B show non-limiting, exemplary dashboards 900a and 900b of user interfaces that may be displayed on computing devices, where dashboards 900a and 900b may map test code coverage to a user story definition, showing any deficiencies in such coverage, such as untested code in relation to the user story definition. In this regard, dashboards 900a and 900b include exemplary user stories for requirements, intended functionalities, goals, features, or other criteria by which a software system, and corresponding software code, may be assessed. Software and other computing code may therefore be analyzed and assessed using testing units and other code tests for adherence to and/or compliance with such user stories. Code tests may determine whether the software code is functioning correctly and/or as intended or desired based on the user stories, and code tests may be required to cover new and/or changed code sufficiently to determine their compliance with user story definitions. Dashboards 900a and 900b may therefore enable viewing of code coverage of these tests for computing code including changes to or modifications of existing tests of new and/or changed code for one or more software applications, programs, processes, and/or systems.

In a user interface displaying dashboard 900a, a user may view user story coverages 902 corresponding to different code coverages of software code for user stories and their definitions. User story definitions may include or identify code functionality, purpose, requirements, goals, features, or other criteria for code use and execution. User story coverages 902 in dashboard 900a may allow a user to view multiple different user stories for a software system to be tested. In this regard, each of the user stories may be used for different definitions and/or requirements of the software system, such as the intended functionalities of that system during runtime and/or use by devices, servers, and/or users. A search 904 may have been executed of the user stories, and the results may return user story definitions 906, which may provide a description, name, identifier, or other information for the corresponding user stories obtained from search 904. A status 908 of each of user story definitions 906 may identify a progress or completion indication of the user story with regard to software design and/or goals set by a developer or other user (e.g., whether the user story has been created and opened, has been accepted for code development, is in progress to being completed, or is done and completed for code development).

Based on testing and determining code coverage of software code associated with fulfilling each of user story definitions 906, as discussed herein, code coverages 910 may be provided in dashboard 900a, which may include percentages or other indicators of code testing coverage for code tests of the software code developed for each corresponding user story definition. In this regard, code coverages 910 may include information indicating the coverage of unit tests and other code tests that may be used for testing the software code. These tests may be used to determine whether the software code is in compliance with, adheres to, and/or completes the corresponding user story definition. As such, code coverages 910 may be used to determine whether modifications of unit tests may be required to determine if software code complies with user story definitions, such as by having a developer modify, change, or add/remove tests or having a machine learning model and/or system automate code test changes.

In a user interface displaying dashboard 900b, a user may view specific information for one of user story definitions 906 or another searched, retrieved, and/or entered user story and corresponding definition, requirements, or the like. In this regard, dashboard 900b may present information for a user story 922 having a user story definition 924 for a functionality to be added to or incorporated in the software system being designed and modified, changed, or otherwise developed using new or changed software code. A summary 926 of user story 922 may provide information regarding a priority level, a status, files, methods for performance, and/or code coverages for unit tests and other code tests. Summary 926 may allow a user to view whether the user story has been completed and/or a percentage or amount of software code coverage of code tests that test the software code of interest and/or for deployment or use. With an overall task, functionality, feature, or goal of user story 922 as established for user story definition 924, subtasks 928 may be required to be performed, satisfied, and/or completed. As such, subtasks 928 may also be provided in dashboard 900b for a user to further track code coverage of code tests for software code for each of subtasks 928.

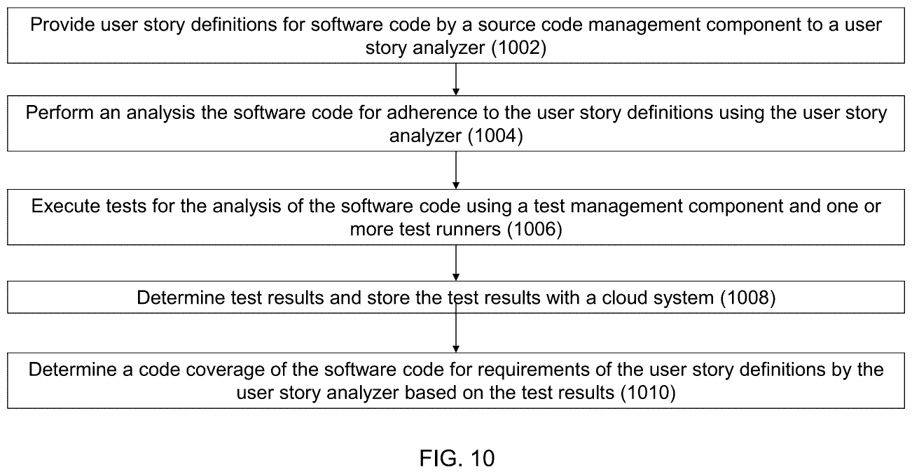

FIG. 10 shows a simplified diagram of an exemplary flowchart for code analysis based on a user story according to some embodiments. Note that one or more steps, processes, and methods described herein of flowchart 1000 may be omitted, performed in a different sequence, or combined as desired or appropriate based on the guidance provided herein. Flowchart 1000 of FIG. 10 shows a process and operations for a code change analysis system that analyzes cod tests of software code based on user story definitions and other requirements for user stories for a corresponding software application, process, or system, as discussed in reference to FIGS. 1-9B. One or more of steps 1002-1010 of flowchart 1000 may be implemented, at least in part, in the form of executable code stored on non-transitory, tangible, machine-readable media that when run by one or more processors may cause the one or more processors to perform one or more of steps 1002-1010. In some embodiments, flowchart 1000 can be performed by one or more computing devices in the previously discussed FIGS. 1-9B.

At step 1002 of flowchart 1000, user story definitions for software code are provided by a source code management component to a user story analyzer. User story definitions may correspond to requirements, functionalities, features, goals, objectives, or other criteria for software or other computing code when coded for, developed for, implemented or deployed in, and utilized with a software application or system a during runtime. As such, the user story definitions may also designate software code, such as one or more code snippets, sections, files, packages, or the like that has been coded, designed, and/or developed for fulfillment of the user story definitions. The software code may correspond to new code, as well as changes or modifications or existing code, which may be implemented with a software system (e.g., one or more software applications run on a device, server, or other machine (real or virtual) and/or distributed over multiple machines (real or virtual)). The software code may therefore require testing to determine whether the software code performs and/or accomplishes the corresponding user story definition(s).

At step 1004 of flowchart 1000, an analysis of the software code for adherence to the user story definitions is performed using the user story analyzer. The analysis may be performed by running or executing one or more tests, such as unit tests or other software code tests, for code performance of the desired task using one or more test runners. The test runners may be used to determine test results based on the tested tasks and the data provided for testing. Thus, the user story and code analyzer may identify tests to be run for the analysis of the software code and may further determine how an analysis of the software code may be performed by the code tests. This analysis may be indicative of code coverage of the code tests for the software code developed.

At step 1006 of flowchart 1000, tests for the analysis of the software code are executed using a test management component and one or more test runners. The tests may correspond to unit tests or other code tests that consider units of code and analyze execution of the units of code for performance, functionality, usage for a task, and the like. In this regard, the tests may be provided and/or created by one or more code developers but may also be procedurally generated by a machine learning model and/or system designed for test modification or adjustment. The machine learning model may therefore modify existing tests so that further coverage for testing software code, including new or changed code may be performed, and fulfillment of different code testing requirements may be met.

At step 1008 of flowchart 1000, test results are determined and stored with a cloud system. Running and/or execution of the tests by the one or more test runners may return tests results, where the test results may be provided to and stored by the cloud system. As such, the test results may be made available for a code test analyzer and/or a test management component for analysis of the tests and determination of whether the tests have covered the software code as performing or accomplishing the user story definition(s) designated for fulfillment. The cloud system may collect and/or aggregate coverage information from different tests and test results, which may be utilized when determining if tests require updating or changing for further testing of software code, such as new, changed, or modified code.

At step 1010 of flowchart 1000, a code coverage of the software code for requirements of the user story definitions is determined by the user story analyzer based on the test results. The code coverage may be determined from the overall coverage information of code tests of the software code from the test results returned. In this regard, the code coverage may indicate how well, such as by a percentage or amount, the code test cover and/or have tested the software code for the software system. The tests may analyze the software code for covering, or performing, completing, fulfilling, etc., the definitions and/or requirements of the user story being analyzed. As such, the code tests may be required to adequately test different portions, interactions, operations, executables, jobs, etc., of code for its performance and/or accomplishment of user story definitions and requirements.

By testing how well or the extent to which code tests cover testing of code changes for the user story definitions, the system may identify how well the user story definitions has been fulfilled or met by the software code (e.g., based on the current or available tests). If testing is not adequately covered for the user story definitions and software code, further tests may be required to be executed and performed to determine code performance of the user story definitions. As such, the code coverage may identify limitations or lack of coverage for certain software code. A machine learning model and system may be utilized to suggest, based on prior tests and test results/coverage, changes to existing tests that may be performed to configure one or more tests for further code testing and determination of code performance, thereby extending or enhancing code coverage of code tests.

As discussed above and further emphasized here, FIGS. 1-10 are merely examples of process 100 and system 200 for code analysis of software code testing coverage based on user stories, which examples should not be used to unduly limit the scope of the claims. One of ordinary skill in the art would recognize many variations, alternatives, and modifications

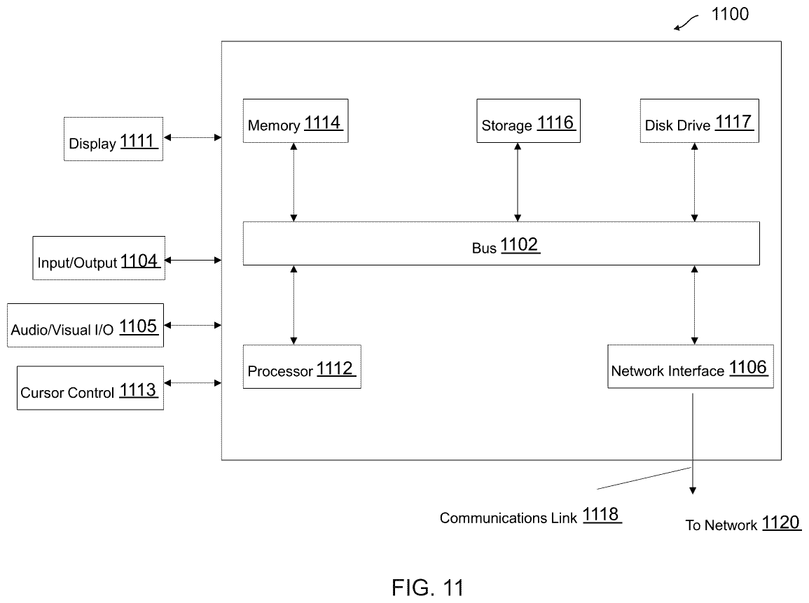

FIG. 11 shows a block diagram of a computer system 1100 suitable for implementing one or more components in FIGS. 1-5 and 7 according to some embodiments. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 1100 in a manner as follows.

Computer system 1100 includes a bus 1102 or other communication mechanism for communicating information data, signals, and information between various components of computer system 1100. Components include an input/output (I/O) component 1104 that processes a user action, such as selecting keys from a keypad/keyboard, selecting one or more buttons, image, or links, and/or moving one or more images, etc., and sends a corresponding signal to bus 1102. I/O component 1104 may also include an output component, such as a display 1111 and a cursor control 1113 (such as a keyboard, keypad, mouse, etc.). An optional audio/visual input/output component 1105 may also be included to allow a user to use voice for inputting information by converting audio signals. Audio/visual I/O component 1105 may allow the user to hear audio, and well as input and/or output video. A transceiver or network interface 1106 transmits and receives signals between computer system 1100 and other devices, such as another communication device, service device, or a service provider server via network 1120. In one embodiment, the transmission is wireless, although other transmission mediums and methods may also be suitable. One or more processors 1112, which can be a micro-controller, digital signal processor (DSP), or other processing component, processes these various signals, such as for display on computer system 1100 or transmission to other devices via a communication link 1118. Processor(s) 1112 may also control transmission of information, such as cookies or IP addresses, to other devices.

Components of computer system 1100 also include a system memory component 1114 (e.g., RAM), a static storage component 1116 (e.g., ROM), and/or a disk drive 1117. Computer system 1100 performs specific operations by processor(s) 1112 and other components by executing one or more sequences of instructions contained in system memory component 1114. Logic may be encoded in a computer readable medium, which may refer to any medium that participates in providing instructions to processor(s) 1112 for execution. Such a medium may take many forms, including but not limited to, non-volatile media, volatile media, and transmission media. In various embodiments, non-volatile media includes optical or magnetic disks, volatile media includes dynamic memory, such as system memory component 1114, and transmission media includes coaxial cables, copper wire, and fiber optics, including wires that comprise bus 1102. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 1100. In various other embodiments of the present disclosure, a plurality of computer systems 1100 coupled by communication link 1118 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A system for analyzing code coverage in relation to user story requirements, the system comprising:
a non-transitory memory; and
one or more hardware processors coupled with the non-transitory memory and configured to read instructions from the non-transitory memory to cause the system to perform operations comprising:
receiving a user story definition for software code that was developed according to the user story definition;
analyzing the software code by an analyzer comprising a machine learning (ML) model configured to refine a plurality of tests of the software code that identify a code coverage of the software code for the user story definition, wherein the analyzing comprises:
managing executions of the plurality of tests for determination of the code coverage of the software code in relation to the user story definition,
performing the plurality of tests using one or more test runners associated with the analyzer and based on the managed executions,
determining test results from the performing the plurality of tests, wherein the test results are usable for an analysis by the analyzer of the code coverage,
performing the analysis of the code coverage of the software code in relation to the user story definition based at least on the test results, wherein the analysis of the code coverage indicates an extent to which the software code has been adequately tested by the plurality of tests for satisfying one or more requirements of the user story definition, and
determining, using at least the ML model and based on the analysis indicating the extent to which the software code has been adequately tested, whether the software code is ready for a release or the plurality of tests require a refinement for a further analysis by the analyzer of the code coverage; and
outputting information associated with whether the software code is ready for the release or the plurality of tests require the refinement for the further analysis based on the analyzing the software code.

2. The system of claim 1, wherein the software code comprises a modification to existing software that includes new code or changed code for the existing software, and wherein the plurality of tests comprises at least one software unit test created by a developer of the existing software.

3. The system of claim 1, wherein the refinement comprises a change to one of the plurality of tests, and wherein the operations further comprise:
determining, based on the plurality of tests requiring the refinement for the further analysis, the change to the one of the plurality of tests by the ML model.

4. The system of claim 1, wherein the user story definition comprises a software requirement for a software system provided by the software code.

5. The system of claim 4, wherein the software requirement is identified by an intended functionality and performance criteria of the software system when executed in a computing environment.

6. The system of claim 1, wherein the analyzing the software code further comprises:
identifying test names, test durations, and test environment names from the test results,
wherein the performing the analysis of the code coverage of the software code is further based on at least one of the test names, the test durations, or the test environment names.

7. The system of claim 1, wherein the user story definition is received from a source code management component comprising at least one third-party source code repository.

8. The system of claim 1, wherein the performing the analysis of the code coverage of the software code includes calculating the code coverage of each test of the plurality of tests executed by the one or more test runners.

9. The system of claim 1, wherein the analysis of the code coverage is performed using a cloud system, and wherein the analyzer pulls coverage information associated with at least the code coverage periodically or in response to a message for a coverage determination.

10. The system of claim 1, wherein the analyzer is configured to obtain modified code or changed code that is related to the user story definition, and wherein the analyzer is further configured to aggregate coverage information for sections of code related to the user story definition and generate a report indicating the extent of the coverage information including the modified code or the changed code.

11. A method for analyzing code coverage in relation to user story requirements, the method comprising:
receiving a user story definition for software code that was developed according to the user story definition;
analyzing the software code by an analyzer comprising a machine learning (ML) model configured to refine a plurality of tests of the software code that identify a code coverage of the software code for the user story definition, wherein the analyzing comprises:
managing executions of the plurality of tests for determination of the code coverage of the software code in relation to the user story definition,
performing the plurality of tests using one or more test runners associated with the analyzer and based on the managed executions,
determining test results from the performing the plurality of tests, wherein the test results are usable for an analysis by the analyzer of the code coverage,
performing the analysis of the code coverage of the software code in relation to the user story definition based at least on the test results, wherein the analysis of the code coverage indicates an extent to which the software code has been adequately tested by the plurality of tests for satisfying one or more requirements of the user story definition, and
determining, using at least the ML model and based on the analysis indicating the extent to which the software code has been adequately tested, whether the software code is ready for a release or the plurality of tests require a refinement for a further analysis by the analyzer of the code coverage; and
outputting information associated with whether the software code is ready for the release or the plurality of tests require the refinement for the further analysis based on the analyzing the software code.

12. The method of claim 11, wherein the software code comprises a modification to existing software that includes new code or changed code for the existing software, and wherein the plurality of tests comprises at least one software unit test created by a developer of the existing software.

13. The method of claim 11, wherein the refinement comprises a change to one of the plurality of tests, and wherein the method further comprises:
determining, based on the plurality of tests requiring the refinement for the further analysis, the change to the one of the plurality of tests by the ML model.

14. The method of claim 11, wherein the user story definition comprises a software requirement for a software system provided by the software code.

15. The method of claim 14, wherein the software requirement is identified by an intended functionality and performance criteria of the software system when executed in a computing environment.

16. The method of claim 11, wherein the analyzing the software code further comprises:
identifying test names, test durations, and test environment names from the test results,
wherein the performing the analysis of the code coverage of the software code is further based on at least one of the test names, the test durations, or the test environment names.

17. The method of claim 11, wherein the user story definition is received from a source code management component comprising at least one of Bitbucket, Github or GitLab.

18. The method of claim 11, wherein the performing the analysis of the code coverage of the software code includes calculating the code coverage of each test of the plurality of tests executed by the one or more test runners.

19. The method of claim 11, wherein the analysis of the code coverage is performed using a cloud system, and wherein the analyzer pulls coverage information associated with at least the code coverage periodically or in response to a message for a coverage determination.

20. A non-transitory computer-readable medium having stored thereon computer-readable instructions executable for analyzing code coverage in relation to user story requirements by a code change analysis system, the computer-readable instructions executable to perform operations which comprise:
receiving a user story definition for software code that was developed according to the user story definition;
analyzing the software code by an analyzer comprising a machine learning (ML) model configured to refine a plurality of tests of the software code that identify a code coverage of the software code for the user story definition, wherein the analyzing comprises:
managing executions of the plurality of tests for determination of the code coverage of the software code in relation to the user story definition,
performing the plurality of tests using one or more test runners associated with the analyzer and based on the managed executions,
determining test results from the performing the plurality of tests, wherein the test results are usable for an analysis by the analyzer of the code coverage,
performing the analysis of the code coverage of the software code in relation to the user story definition based at least on the test results, wherein the analysis of the code coverage indicates an extent to which the software code has been adequately tested by the plurality of tests for satisfying one or more requirements of the user story definition, and
determining, using at least the ML model and based on the analysis indicating the extent to which the software code has been adequately tested, whether the software code is ready for a release or the plurality of tests require a refinement for a further analysis by the analyzer of the code coverage; and
outputting information associated with whether the software code is ready for the release or the plurality of tests require the refinement for the further analysis based on the analyzing the software code.
